(19) United States
(12) Patent Application Publication
(10) Pub. No.: US 2011/0013824 A1
(43) Pub. Date: Jan. 20, 2011

(54) INSPECTION AREA SETTING METHOD, INSPECTION AREA SETTING APPARATUS, AND COMPUTER PROGRAM PRODUCT

(76) Inventor: Yasuyuki YAMADA, Kanagawa (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/697,574

(22) Filed: Feb. 1, 2010

(30) Foreign Application Priority Data
Jul. 17, 2009 (JP) 2009-168774

(51) Int. Cl. G06K 9/00

(52) U.S. Cl. 382/149; 382/190; 382/224

(57) ABSTRACT

To provide an inspection area setting method including: extracting patterns from a plurality of sampling positions in a design layout data of a die of a semiconductor integrated circuit; classifying the extracted patterns into a plurality of types fewer than number of the extracted patterns, based on similarity of geometric feature attributes; and fixing a plurality of candidate areas smaller than a size of the die, and setting a candidate area including the largest number of types of the patterns classified at classifying, among the fixed candidate areas, as an inspection area in defect inspection.

### CROSS-REFERENCE TO RELATED APPLICATIONS

This application is based upon and claims the benefit of priority from the prior Japanese Patent Application No. 2009-168774, filed on Jul. 17, 2009; the entire contents of which are incorporated herein by reference.

### BACKGROUND OF THE INVENTION

1. Field of the Invention

The present invention relates to an inspection area setting method, an inspection area setting apparatus, and a computer program product.

2. Description of the Related Art

For example, conditions of optimum exposure and optimum focus of photolithography vary according to geometric feature attributes such as coarseness, line width, and coverage ratio of a pattern. Therefore, ranges of the exposure condition and the focus condition (a process window) for bringing an error within an allowable range may change locally even on a same die. Generally, the exposure condition and focus condition are selected from a process window in common for an entire wafer.

However, the margin of the process window is becoming smaller along with higher integration of semiconductor integrated circuits in recent years, and the influence of fluctuations in various conditions of a manufacturing process including a lithography condition is relatively increasing. That is, the photolithography may be performed locally under a condition deviating from the process window due to the influence of fluctuations in various conditions of the manufacturing process. When the lithography is performed under the condition deviating from the process window, there is a high possibility that a defect such as short-circuit between patterns or disconnection occurs in the deviated position. To improve yield, it is important to perform an operation of inspecting whether a systematic defect, which is a defect related to a manufacturing process and geometric feature attributes of a pattern, has occurred and of feeding back the result of the inspection to various conditions of the manufacturing process.

A defect inspection method effective for detecting systematic defects includes die-to-database comparison inspection in which a wafer having a pattern formed thereon is inspected by a scanning electron microscope (SEM) and a generated inspection pattern is compared with design layout data. The die-to-database comparison inspection has a disadvantage of low throughput, although systematic defects can be found highly accurately. Therefore, conventionally, to improve the throughput, an inspection area for acquiring an inspection pattern and comparing the inspection pattern with design layout data is not set as the entire die, but an operation in which an inspection area is narrowed down to a part of a die based on the performance of an inspection apparatus and a required turn around time (TAT) has been performed. However, because setting of the inspection area has been performed manually by an engineer based on his experience, a setting error due to a manual operation and omission of the inspection area due to preconception occur, and this causes to a critical miss of defects. That is, there has been a problem that only skilled and experienced engineers can set an inspection area in which highly accurate defect inspection can be performed.

As a technique related to a pattern defect inspection method, Japanese Patent Application Laid-Open No. 2004-191957 discloses a technique in which patterns are classified into a plurality of ranks according to a predetermined criterion, inspection accuracy is determined for each rank, and the quality of a photomask is determined according to whether the determined inspection accuracy is satisfied. According to this technique, the inspection time can be reduced because its inspection accuracy of a pattern such as a dummy pattern, with which can lower accuracy is allowed, is decreased to perform the inspection. However, in Japanese Patent Application Laid-Open No. 2004-191957, there is no disclosure of a technique for easily performing a step of classifying patterns into ranks, which is particularly important for performing accurate defect inspection even by inexperienced engineers.

Further, Japanese Patent Application Laid-Open No. H5-47882 discloses a technique in which an inspection method is set based on an individual image field class of a wafer surface, and surface information of the individual image field is compared with reference information generated based on surface information detected beforehand from a plurality of wafer surfaces having the same structure in the same manufacturing process, based on the set method. In this technique, to perform accurate defect inspection, it is particularly important to appropriately perform classification of the individual image field. However, in Japanese Patent Application Laid-Open No. H5-47882, there is no disclosure of a technique for easily performing the classification.

### BRIEF SUMMARY OF THE INVENTION

An inspection area setting method according to an embodiment of the present invention comprises:

extracting patterns from a plurality of sampling positions in a design layout data of a die of a semiconductor integrated circuit;

classifying the extracted patterns into a plurality of types fewer than number of the extracted patterns, based on similarity of geometric feature attributes; and

first setting including
fixing a plurality of candidate areas smaller than a size of the die, and
setting a candidate area including largest number of types of the patterns classified at classifying, among the fixed candidate areas, as an inspection area in defect inspection.

An inspection area setting apparatus according to an embodiment of the present invention comprises:

a pattern extracting unit that extracts patterns from a plurality of sampling positions in a design layout data of a die of a semiconductor integrated circuit;

a pattern-classification/distribution generating unit that classifies the extracted patterns into a plurality of types fewer than number of the extracted patterns, based on similarity of geometric feature attributes; and

a space-searching/inspection-area determining unit that fixes a plurality of candidate areas smaller than a size of the die and sets a candidate area including largest number of types of the patterns classified by the pattern-classification/distribution generating unit, among the fixed candidate areas, as an inspection area in defect inspection.

A computer program product according to an embodiment of the present invention includes a plurality of computer executable commands for causing a computer to execute:

extracting patterns from a plurality of sampling positions in a design layout data of a die of a semiconductor integrated circuit;

classifying the extracted patterns into a plurality of types fewer than number of the extracted patterns, based on similarity of geometric feature attributes; and

first setting including
fixing a plurality of candidate areas smaller than a size of the die, and
setting a candidate area including largest number of types of the patterns classified by classifying, among the fixed candidate areas, as an inspection area in defect inspection.

### BRIEF DESCRIPTION OF THE DRAWINGS

FIG. 1 is a schematic diagram for explaining characteristics of an embodiment of the present invention;

FIG. 2 is a schematic diagram for explaining a configuration of an inspection area setting apparatus according to the embodiment;

FIG. 3 is a flowchart for explaining an inspection area setting method according to the embodiment;

FIG. 4 is a schematic diagram for explaining an example of pattern extraction;

FIG. 5 is a schematic diagram for explaining a state where patterns are classified;

FIG. 6 is a flowchart for explaining a space-searching/inspection-area determining process in detail;

FIG. 7 is a schematic diagram for explaining a state where a count value and a total score;

FIG. 8 is a schematic diagram for explaining an example in which an inspection area candidate is two rectangular areas; and

FIG. 9 is a schematic diagram for explaining a hardware configuration of the inspection area setting apparatus according to the embodiment.

### DETAILED DESCRIPTION OF THE INVENTION

Exemplary embodiments of an inspection area setting method, an inspection area setting apparatus, and a computer program product according to the present invention will be explained below in detail with reference to the accompanying drawings. The present invention is not limited to the following embodiments.

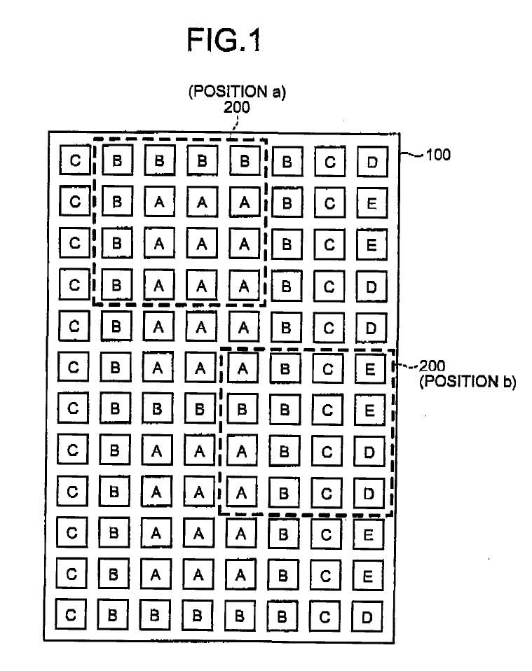

An inspection area setting apparatus according to an embodiment of the present invention extracts peripheral patterns of a plurality of coordinate points in a design layout data of a die, and automatically classifies each of the extracted patterns based on geometric feature attributes, and automatically determines an inspection area including classification patterns as many as possible. FIG. 1 is a schematic diagram for explaining characteristics of the present embodiment. According to the configuration shown in FIG. 1, patterns are extracted from 96 sampling points (positions) of “8×12 (columns×rows)” in total on a design layout data 100 of the die, and the respective extracted patterns are classified into five types of classification patterns in total, that is, classification patterns A to E. An inspection area 200 has an area for covering sampling points of “4×4”. For example, when the inspection area 200 is a position a, inspection can be performed only for patterns classified as A and B. In other words, the inspection time can be reduced (the throughput is improved) by narrowing down the inspection area 200 to a size not for covering the entire die, but for covering the sampling points of “4×4”. However, systematic defects resulting from patterns classified into classification patterns C to E will be missed, and thus highly accurate defect inspection cannot be performed. Meanwhile, at a position b, the inspection area 200 includes all of the classification patterns A to E, and defects in the classification patterns A to E can be inspected. That is, highly accurate defect inspection can be performed by setting the position b as the inspection area 200 rather than the position a. In the present embodiment, it is a main characteristic that an inspection area including more classification patterns is automatically searched and determined (set) so that highly accurate defect inspection can be performed.

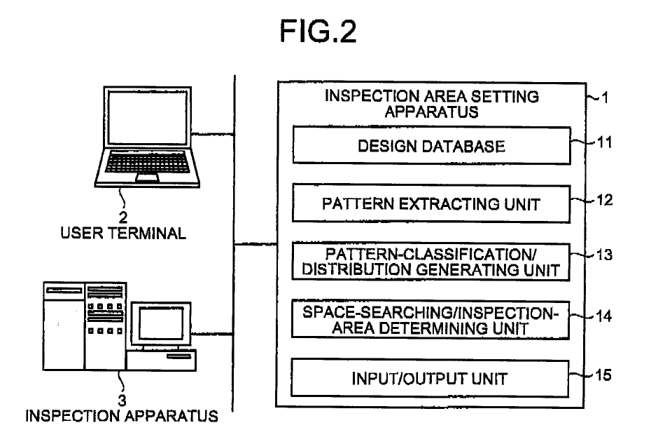

FIG. 2 is a schematic diagram for explaining a configuration of the inspection area setting apparatus for realizing the characteristic described above. A user terminal 2 and an inspection apparatus 3 are connected to an inspection area setting apparatus 1 via a network such as Ethernet®. A user operates the user terminal 2 to operate the inspection area setting apparatus 1, to set an inspection area of a die formed on a wafer to be inspected. The inspection area setting apparatus 1 transmits the set inspection area to the inspection apparatus 3. The inspection apparatus 3 examines the set inspection area in the die on the wafer by an SEM, to generate an inspection image of the area. The inspection apparatus 3 compares the generated inspection image and design layout data of the set inspection area with each other, and detects a difference exceeding an allowable range as a defect.

An inspection target pattern can be a pattern formed at any stage in a manufacturing process. That is, the inspection target pattern can be a pattern transferred by exposure or a pattern after being etched. Further, the inspection target pattern can be a pattern formed by nanoimprinting. The inspection apparatus 3 can be an apparatus that generates an inspection image by an examining unit other than an SEM. For example, the inspection apparatus 3 can be an apparatus that generates an inspection image by irradiating charged particles, such as a particles.

The inspection area setting apparatus 1 includes a design database 11 that accumulates design layout data, a pattern extracting unit 12 that extracts patterns from the design layout data accumulated in the design database 11, a pattern-classification/distribution generating unit 13 that classifies the patterns extracted by the pattern extracting unit 12 based on similarity of geometric feature attributes and generates a distribution (a spatial distribution) for each classification pattern on a die such as the pattern shown in FIG. 1, a space-searching/inspection-area determining unit 14 that searches for a position of an inspection area including classification patterns as many as possible based on the spatial distribution generated by the pattern-classification/distribution generating unit 13 and determines the inspection area, and an input/output unit 15 that receives an operation input from the user terminal 2 and transmits the inspection area determined by the space-searching/inspection-area determining unit 14 to the inspection apparatus 3.

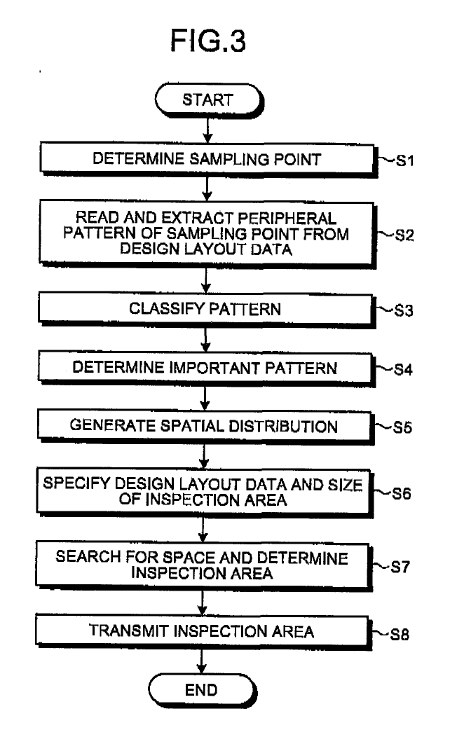

FIG. 3 is a flowchart for explaining an inspection area setting method performed by the inspection area setting apparatus 1.

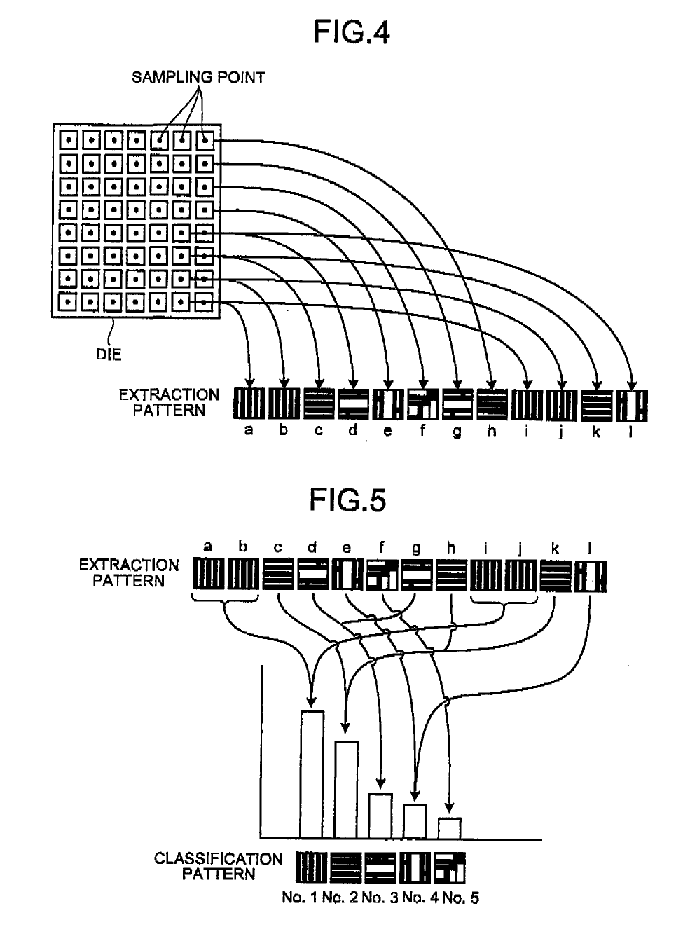

As shown in FIG. 3, the pattern extracting unit 12 determines a sampling point in a die (Step S1). The pattern extracting unit 12 then reads peripheral patterns of the determined sampling point from the design layout data stored in the design database 11 and extracts a pattern (Step S2). A size of an area extracted from one sampling point is not particularly limited; however, for example, it can be a size taking into consideration a distance affected by an optical proximity effect. For example, the pattern extracting unit 12 can extract patterns from a several square-micrometer rectangular area centering on the sampling point. FIG. 4 is a schematic diagram for explaining an example of pattern extraction performed by the pattern extracting unit 12. In the example shown in FIG. 4, patterns a to l are extracted from 12 positions in total on the right side of the drawing in a design layout data of a die.

Subsequently, the pattern-classification/distribution generating unit 13 classifies the extracted patterns (hereinafter, “extraction patterns”) based on similarity of geometric feature attributes (Step S3). Specifically, for example, as the geometric feature attributes, at least one of a minimum line width, a minimum space width, a line-width mean value, a space-width mean value, a coverage ratio, and the number of vertexes can be used. For example, there can be considered a method in which geometric feature attributes are divided by a predetermined step size, and it is set that extraction patterns included in each divided region have a high similarity with each other, and extraction patterns included in each divided region are respectively the same classification pattern. Further, the similarity of geometric feature attributes can be evaluated by at least one of exclusive OR of extraction patterns, a cross-correlation coefficient, a ratio of minimum line width, a ratio of minimum space width, a ratio of line-width mean value, a ratio of space-width mean value, a ratio of two coverage ratio, and a ratio of the number of vertexes. For example, there can be considered a method in which extraction patterns having the similarity of geometric feature attributes equal to or larger than a predetermined threshold are classified into the same classification pattern. For classification based on the similarity of geometric feature attributes, known classification methods such as cluster analysis and other classification methods that will be newly developed in the future can be used other than the method described above, in which extraction patterns having similarity equal to or larger than a predetermined threshold are classified into the same classification pattern.

FIG. 5 is a schematic diagram for explaining a state where 12 extraction patterns extracted according to the example shown in FIG. 4 are classified into five classification patterns (classification patterns No. 1 to No. 5) by the pattern-classification/distribution generating unit 13. As shown in FIG. 5, extraction patterns a, b, i, and j are classified into the classification pattern No. 1, which is a line and space in which a plurality of lines extending vertically is arranged horizontally with equal intervals. Extraction patterns c, h, and k are classified into the classification pattern No. 2, which is a line and space in which a plurality of lines extending horizontally is arranged vertically with equal intervals. Extraction patterns d and g are classified into the classification pattern No. 3, which is a pattern in which two H-shaped patterns rotated by 90 degrees are arranged vertically next to each other. Extraction patterns e and l are classified into the classification pattern No. 4, which is a pattern in which two H-shaped patterns are arranged horizontally next to each other. Extraction pattern f is classified into the classification pattern No. 5. The frequency of appearance of the classification patterns No. 1 to No. 5 increases in this order.

Subsequently, the pattern-classification/distribution generating unit 13 sets a predetermined number of classification patterns having the highest frequency of appearance as important patterns (Step S4), and generates a spatial distribution for each classification pattern set as the important patterns (Step S5). For example, when it is assumed that there are 1000 classification patterns, 50 types of patterns having the highest frequency of appearance among these are designated as the important patterns. The data structure of the spatial distribution is not particularly limited; however, the spatial distribution can have a data structure as image data shown in FIG. 1. The spatial distribution can have a data structure of a table format in which a coordinate of a sampling point and an identification number of a classification pattern are related to each other.

Steps S1 to S5 can be performed in advance for each element of design layout data.

Subsequently, a user specifies design layout data and a size (area) of the inspection area of the die for which the inspection area is set (Step S6). More specifically, the user inputs a designation of the design layout data and a specification of the size of the inspection area to the user terminal 2. The input information is received by the input/output unit 15. The size of the inspection area 200 is determined based on the performance of the inspection apparatus and the inspection time allowed for inspection per die. For example, when inspection is performed in 24 hours per wafer on which 24 dies are formed, it is required to complete inspection of one die in one hour. In this case, the user can specify the size of the inspection area as a size for which the inspection apparatus 3 can execute the inspection in one hour at maximum.

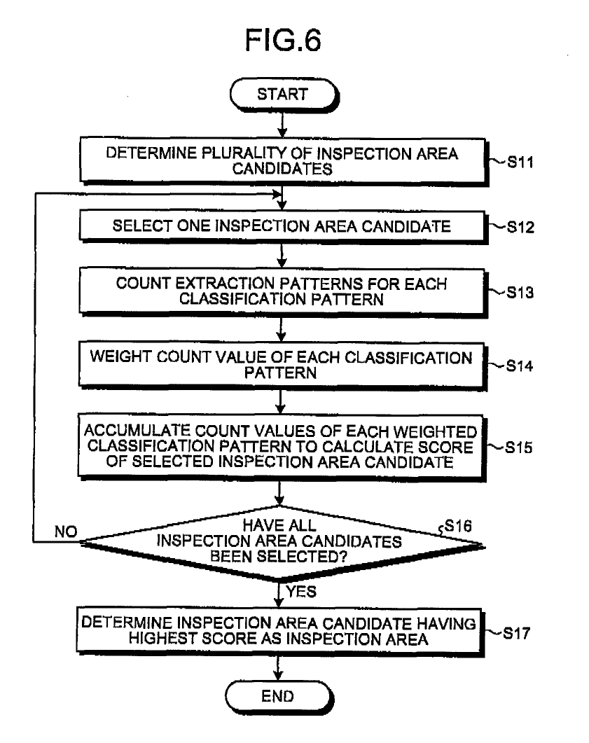

Subsequent to Step S6, the space-searching/inspection-area determining unit 14 searches for a position of the inspection area including classification patterns as many as possible based on information received by the input/output unit 15 and a spatial distribution generated by the pattern-classification/distribution generating unit 13, and determines the inspection area (Step S7). FIG. 6 is a flowchart for explaining a space-searching/inspection-area determining process at Step S7 in detail.

As shown in FIG. 6, the space-searching/inspection-area determining unit 14 first sets a plurality of inspection area candidates (Step S11). The space-searching/inspection-area determining unit 14 then selects one of the set inspection area candidates (Step S12), and counts the extraction patterns included in the selected inspection area candidates for each classification pattern (Step S13). The space-searching/inspection-area determining unit 14 then applies a weighting function to a count value of each classification pattern to calculate a score of classification pattern (Step S14). As the weighting function, a function having a property such that an increasing rate with respect to the count value of the score decreases continuously or in stepwise with an increase of the count value is used. For example, such a function that first count is set to 10 points, and one point each is added from the second count is used. The space-searching/inspection-area determining unit 14 accumulates the score of each classification pattern to set a score of the selected inspection area candidate (Step S15). The space-searching/inspection-area determining unit 14 determines whether all of the inspection area candidates are selected (Step S16). When all of the inspection area candidates have not been selected (NO at Step S16), the space-searching/inspection-area determining unit 14 proceeds to Step S12 to select one unselected inspection area candidate. When all of the inspection area candidates have been selected (YES at Step S16), the space-searching/inspection-area determining unit 14 determines an inspection area candidate with the highest score as the inspection area, and process returns to the process at Step S7.

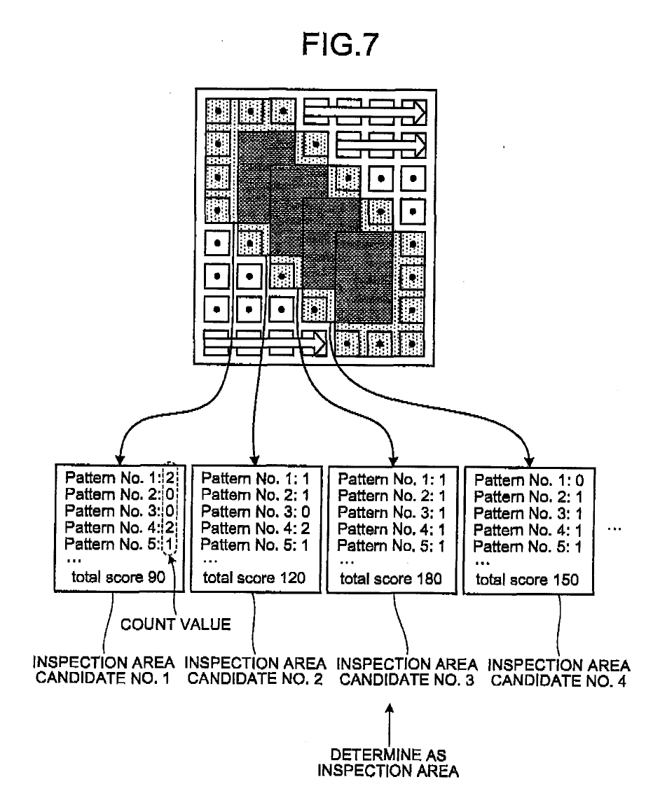

By increasing the increasing rate of the score for each classification pattern with a decrease of the count value, the inspection area candidate at a position including more classification patterns can acquire a higher score even when the total number of counts is the same, and an inspection area including more classification patterns can be set. FIG. 7 is a schematic diagram for explaining a state where a count value for each classification pattern (No. 1, No. 2, No. 3, No. 4, No. 5, onwards) for a plurality of inspection area candidates and a total score are calculated with respect to a plurality of inspection area candidates (No. 1, No. 2, No. 3, No. 4, onwards). As shown in FIG. 7, the score of the inspection area candidate No 3 that uniformly includes the classification patterns No. 1 to No. 5 has the highest score, and thus the inspection area candidate No. 3 is set as the inspection area.

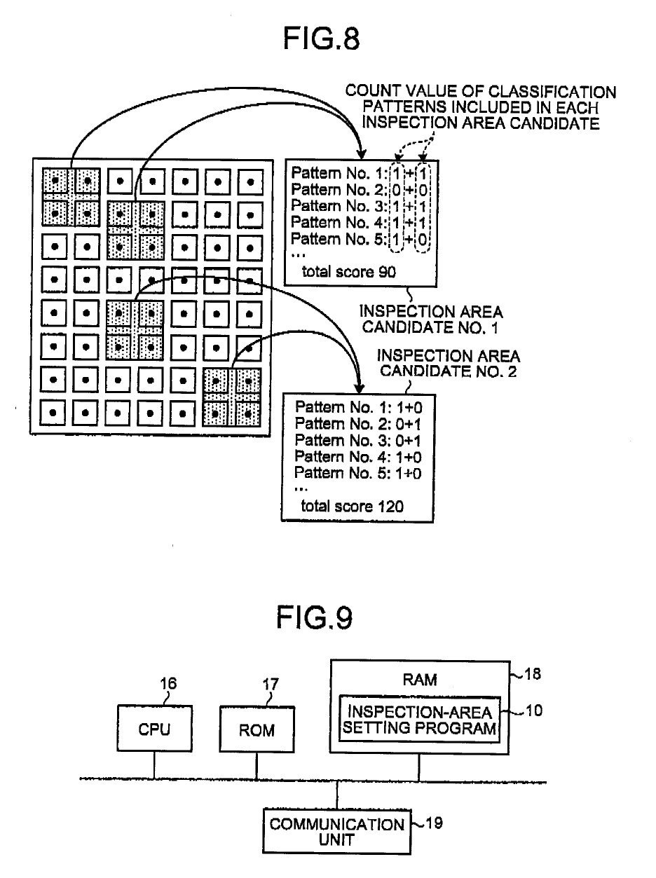

The inspection area can be divided into plural numbers, so long as each area has a specified size, and for example, two or more rectangular areas can be set as the inspection area. In this case, the space-searching/inspection-area determining unit 14 provides a minimum line for the score for determining the inspection area, and performs spatial search, designating one rectangular area as the inspection area candidate. When the score of the inspection area candidate does not satisfy the minimum line at any position, the space-searching/inspection-area determining unit 14 can divide the inspection area candidate into two rectangular areas having a total area same as the area before division, to determine each inspection area candidate in which the score based on a total count value of the two divided rectangular areas exceeds the minimum line and becomes highest as the inspection area. FIG. 8 is a schematic diagram for explaining an example in which the inspection area candidate is two rectangular areas. In FIG. 8, it is shown that the inspection area candidate No. 1 has a high score based on the count value of respective divided areas; however, when areas divided into two are added, the inspection area candidate No. 2 includes more classification patterns and has a higher total score. When the inspection apparatus 3 can perform defect inspection with respect to an inspection area having a shape other than rectangle, the inspection area does not need to be rectangular.

Referring back to FIG. 3, the input/output unit 15 transmits the inspection area determined by the space-searching/inspection-area determining unit 14 to the inspection apparatus 3 (Step S8), and the operation is completed.

In the explanations of the inspection area setting method, the pattern-classification/distribution generating unit 13 sets a predetermined number of classification patterns having the highest frequency of appearance as the important pattern, and generates a spatial distribution regarding the important pattern. However, when the number of classification patterns is smaller, it is possible that the important pattern is not defined and the spatial distribution can be generated for all of the classification patterns.

Further, while it has been explained above that the input/output unit 15 transmits the inspection area determined by the space-searching/inspection-area determining unit 14 to the inspection apparatus 3, the determined inspection area can be transmitted to the user terminal 2.

The inspection area setting apparatus 1 can be realized by executing a program on hardware having a computer configuration of a normal server type. FIG. 9 is a schematic diagram for explaining a hardware configuration of the inspection area setting apparatus 1. As shown in FIG. 9, the inspection area setting apparatus 1 includes a central processing unit (CPU) 16, a read only memory (ROM) 17, a random access memory (RAM) 18, and a communication unit 19. The CPU 16, the ROM 17, the RAM 18, and the communication unit 19 are connected to each other via a bus line.

The CPU 16 executes an inspection-area setting program 10, which is a computer program for performing the inspection area setting method. The communication unit 19 is a network interface for communicating with the user terminal 2 and the inspection apparatus 3. The communication unit 19 transmits output information with respect to a user of an operation screen and the like to the user terminal 2 based on an instruction from the CPU 16. An operation input of the inspection area setting apparatus 1 from the user terminal 2 is input to the communication unit 19. The operation input that is input to the communication unit 19 is transmitted to the CPU 16.

The inspection-area setting program 10 is stored in the ROM 17, and loaded into the RAM 18 via a bus line. The CPU 16 executes the inspection-area setting program 10 loaded into the RAM 18. Specifically, the CPU 16 reads the inspection-area setting program 10 from the ROM 17 and expands the program in a program storage area in the RAM 18, and temporarily stores work data generated at the time of performing the inspection area setting method, such as a spatial distribution and a score of each inspection area candidate, in a data storage area formed in the RAM 18. The CPU 16 sets an inspection area by using the data stored temporarily in the data storage area, and causes the communication unit 19 to transmit the set inspection area to the inspection apparatus 3. The inspection-area setting program 10 can be stored in a memory such as a disk. The inspection-area setting program 10 can be also loaded into a memory such as a disk.

The inspection-area setting program 10 executed by the inspection area setting apparatus 1 according to the present embodiment has a configuration to include the respective units described above (the pattern extracting unit 12, the pattern-classification/distribution generating unit 13, the space-searching/inspection-area determining unit 14, and the input/output unit 15), so that the respective units are loaded into the RAM 18 to generate the pattern extracting unit 12, the pattern-classification/distribution generating unit 13, the space-searching/inspection-area determining unit 14, and the input/output unit 15 in the RAM 18. The design database 11 is held in an external memory (not shown). The design database 11 can be held in a memory accessible via a network.

Further, it can be configured such that the inspection-area setting program 10 executed by the inspection area setting apparatus 1 is stored on a computer connected to a network such as the Internet, downloaded via the network, and provided. Further, the inspection-area setting program 10 executed by the inspection area setting apparatus 1 according to the present embodiment can be provided or distributed via a network such as the Internet. The inspection-area setting program 10 according to the present embodiment can be incorporated in the ROM 17 or the like in advance and provided to the inspection area setting apparatus 1.

The inspection-area setting program 10 can be executed by the user terminal 2, not by a computer of a server type, so that the inspection area setting method is performed on the user terminal 2. Further, the inspection-area setting program 10 can be executed on a control computer attached to the inspection apparatus 3, thereby performing the inspection area setting method by the inspection apparatus 3.

As described above, according to the present embodiment, patterns are extracted from a plurality of sampling positions in a design layout data, the extraction patterns are classified based on similarity of geometric feature attributes, and a candidate area including the largest number of classification patterns is set as an inspection area by a defect inspection apparatus. Therefore, setting of an inspection area in which a defect of a pattern formed on a wafer can be detected highly accurately can be easily performed.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An inspection area setting method comprising:
extracting patterns from a plurality of sampling positions in a design layout data of a die of a semiconductor integrated circuit;
classifying the extracted patterns into a plurality of types fewer than number of the extracted patterns, based on similarity of geometric feature attributes; and
first setting including
fixing a plurality of candidate areas smaller than a size of the die, and
setting a candidate area including largest number of types of the patterns classified at classifying, among the fixed candidate areas, as an inspection area in defect inspection.

2. The inspection area setting method according to claim 1, wherein the first setting includes:
counting patterns included in the fixed candidate area for each of the classified types;
calculating including
calculating a score of each of the types by applying a predetermined function respectively to a count value of each of the types, and
accumulating the calculated score of each of the types for each of the fixed candidate areas to calculate a score for each of the fixed candidate areas; and
determining a candidate area to be set as an inspection area from the fixed candidate areas based on the calculated score.

3. The inspection area setting method according to claim 2, wherein the predetermined function is a weighting function having a property such that an increasing rate with respect to a count value of a score decreases with an increase of the count value.

4. The inspection area setting method according to claim 3, wherein the determining is determining a candidate area having a highest score as an inspection area.

5. The inspection area setting method according to claim 1, wherein the geometric feature attributes are at least one of a minimum line width, a minimum space width, a line-width mean value, a space-width mean value, a coverage ratio, and number of vertexes.

6. The inspection area setting method according to claim 1, further comprising second setting of setting a predetermined number of types of the classified patterns as important types in order of from one having a highest frequency of appearance, wherein
the first setting is setting a candidate area including largest number of types set as the important types as the inspection area.

7. The inspection area setting method according to claim 6, wherein the first setting includes:
counting patterns included in the fixed candidate area for each of the important types;
calculating including
calculating a score of each important type by applying a predetermined function respectively to a count value of each of the important types, and
accumulating the calculated score of each important type for each of the fixed candidate areas to calculate a score for each of the fixed candidate areas; and
determining a candidate area to be set as an inspection area from the fixed candidate areas based on the calculated score.

8. The inspection area setting method according to claim 7, wherein the predetermined function is a weighting function having a property such that an increasing rate with respect to a count value of a score decreases with an increase of the count value.

9. The inspection area setting method according to claim 8, wherein the determining is determining a candidate area having a highest score as an inspection area.

10. An inspection area setting apparatus comprising:
a pattern extracting unit that extracts patterns from a plurality of sampling positions in a design layout data of a die of a semiconductor integrated circuit;
a pattern-classification/distribution generating unit that classifies the extracted patterns into a plurality of types fewer than number of the extracted patterns, based on similarity of geometric feature attributes; and
a space-searching/inspection-area determining unit that fixes a plurality of candidate areas smaller than a size of the die and sets a candidate area including largest number of types of the patterns classified by the pattern-classification/distribution generating unit, among the fixed candidate areas, as an inspection area in defect inspection.

11. The inspection area setting apparatus according to claim 10, wherein space-searching/inspection-area determining unit counts patterns included in the fixed candidate area for each of the classified types, calculates a score of each of the types by applying a predetermined function respectively to a count value of each of the types, and accumulates the calculated score of each of the types for each of the fixed candidate areas to calculate a score for each of the fixed candidate areas, and determines a candidate area to be set as an inspection area from the fixed candidate areas based on the calculated score.

12. A computer program product including a plurality of computer executable commands for causing a computer to execute:
extracting patterns from a plurality of sampling positions in a design layout data of a die of a semiconductor integrated circuit;
classifying the extracted patterns into a plurality of types fewer than number of the extracted patterns, based on similarity of geometric feature attributes; and
first setting including
fixing a plurality of candidate areas smaller than a size of the die, and
setting a candidate area including largest number of types of the patterns classified by classifying, among the fixed candidate areas, as an inspection area in defect inspection.

13. The computer program product according to claim 12, wherein the first setting includes:
counting patterns included in the fixed candidate area for each of the classified types;
calculating including
calculating a score of each of the types by applying a predetermined function respectively to a count value of each of the types, and
accumulating the calculated score of each of the types for each of the fixed candidate areas to calculate a score for each of the fixed candidate areas; and
determining a candidate area to be set as an inspection area from the fixed candidate areas based on the calculated score.

14. The computer program product according to claim 13, wherein the predetermined function is a weighting function having a property such that an increasing rate with respect to a count value of a score decreases with an increase of the count value.

15. The computer program product according to claim 14, wherein the determining is determining a candidate area having a highest score as an inspection area.

16. The computer program product according to claim 12, wherein the geometric feature attributes are at least one of a minimum line width, a minimum space width, a line-width mean value, a space-width mean value, a coverage ratio, and number of vertexes.

17. The computer program product according to claim 12, wherein the commands further causes the computer to execute second setting of setting a predetermined number of types of the classified patterns as important types in order of from one having a highest frequency of appearance, wherein
the first setting is setting a candidate area including largest number of types set as the important types as the inspection area.

18. The computer program product according to claim 17, wherein the first setting includes:
counting patterns included in the fixed candidate area for each of the important types;
calculating including
calculating a score of each important type by applying a predetermined function respectively to a count value of each of the important types, and
accumulating the calculated score of each important type for each of the fixed candidate areas to calculate a score for each of the fixed candidate areas; and
determining a candidate area to be set as an inspection area from the fixed candidate areas based on the calculated score.

19. The computer program product according to claim 18, wherein the predetermined function is a weighting function having a property such that an increasing rate with respect to a count value of a score decreases with an increase of the count value.

20. The computer program product according to claim 19, wherein the determining is determining a candidate area having a highest score as an inspection area.
